(19) United States
(12) Patent Application Publication
(10) Pub. No.: US 2015/0244280 A1
(43) Pub. Date: Aug. 27, 2015

(54) DIRECT CURRENT POWER TRANSMISSION NETWORKS OPERATING AT DIFFERENT VOLTAGES

(71) Applicant: ABB TECHNOLOGY LTD, Zürich (CH)

(72) Inventor: Mats Andersson, Beijing (CN)

(73) Assignee: ABB TECHNOLOGY LTD, ZÜRICH (CH)

(21) Appl. No.: 14/429,897

(22) PCT Filed: Sep. 9, 2013
(86) PCT No.: PCT/EP2013/068538

§ 371 Date: Mar. 20, 2015

(30) Foreign Application Priority Data
Sep. 24, 2012 (CN) 201210356843.6

(51) Int. Cl. H02M 5/42

(52) U.S. Cl. CPC H02M 5/42

(57) ABSTRACT

A direct current power transmission system includes a first direct current power transmission network operating at a first voltage level for delivering power to a second direct current power transmission network operating at a second voltage level, where the first direct current power transmission network comprised a group of rectifiers, each connected to an alternating current source, a DC/DC converter station including at least one DC/DC converter providing an interface between the first and second direct current power transmission networks, and a group of transmission lines, each connected between a corresponding rectifier and the DC/DC converter station.

### FIELD OF INVENTION

The present invention generally relates to electrical power transmission. More particularly the present invention relates to a direct current power transmission system comprising a first direct current power transmission network operating at a first voltage level for delivering power to a second direct current power transmission network operating at a second voltage level.

### BACKGROUND

It is well known to transfer power from a source, such as a generator, to a load.

U.S. Pat. No. 6,437,996 does for instance disclose one way in which this may be done. In this document a generator produces a first AC voltage. A current converter circuit transforms the first AC voltage into a third AC voltage and a first transformer converts the third AC voltage into a fourth AC voltage. Thereafter a first rectifier converts the fourth AC voltage into a first DC voltage which is transferred by way of a transmission line into an electrical AC voltage network having a second AC voltage.

The differences in geography concerning transmission of power from a source to a load may lead to problems.

If for instance direct current (DC) power transmission is to be employed between the source and the load, then the geography may cause problems. If there is for instance a plateau at a high altitude that has to be passed then there may occur problems relating to the required voltage levels. In the transfer of power long distances, high voltage direct current (HVDC) is a preferred method, where voltages of 800 kV and sometimes even higher voltages are used. HVDC provides efficient power transfer with low losses. However, there is one problem that needs attention. If transferring power at high altitudes, the size of the isolation of equipment has to be considered. The size needed for sufficient isolation varies depending on the height above sea level. The size of the isolation may thus become forbiddingly high if the altitude is high and the voltage is high.

There is therefore a need to address this situation.

The present invention is therefore directed towards allowing the size of the isolation to be reduced when transmitting of power from a source to a load using HVDC.

### SUMMARY OF THE INVENTION

One object of the present invention is to provide a direct current power transmission system where the size of isolation may be reduced when transmitting power from a source to a load using HVDC.

This object is according to a first aspect of the present invention solved through a direct current power transmission system comprising a first direct current power transmission network operating at a first voltage level for delivering power to a second direct current power transmission network operating at a second voltage level, the first direct current power transmission network comprising
a group of rectifiers, each connected to an alternating current source,
a DC/DC converter station comprising at least one DC/DC converter providing an interface between the first and second direct current power transmission networks, and
a group of transmission lines, each connected between a corresponding rectifier and the DC/DC converter station.

The second voltage level is with advantage higher than the first voltage level. It may as an example be at least two times higher than the first voltage level. It may as another example be at least three times higher than the first voltage level.

In one embodiment of the invention, the direct current power transmission system also comprises the second direct current power transmission network. In thus case the second direct current power transmission network may comprise an inverter for delivering power to an AC network.

The DC/DC converter station may comprise a single DC/DC converter with all rectifiers connected to the single DC/DC converter in parallel.

As an alternative the DC/DC converter station may comprise a group of DC/DC converters, one for every rectifier and connected in parallel to the second direct current power transmission network, where each rectifier is connected to a corresponding DC/DC converter.

The present invention has a number of advantages. The use of a different voltage in the first direct current power transmission network as compared with the second direct current power transmission network enables a reduction of the insulation level used in one of the networks, which may be of importance if parts of this network is provided at a high altitude above sea level.

### BRIEF DESCRIPTION OF THE DRAWINGS

The present invention will in the following be described with reference being made to the accompanying drawings, where

FIG. 1 schematically shows a first embodiment of the invention where a first DC network is connected to a second DC network, and

FIG. 2 schematically shows a second embodiment of the invention with an alternative connection of the first DC network to the second DC network.

### DETAILED DESCRIPTION OF THE INVENTION

In the following, a detailed description of preferred embodiments of a direct current power transmission system according to the present invention will be given.

The invention is concerned with the problem of providing high voltage direct current (HVDC) transmission at high altitudes. The isolation required of equipment employed for power transmission at high altitudes is in many cases too bulky to be feasible, especially at some of the high voltages that are needed for the efficiency that is required.

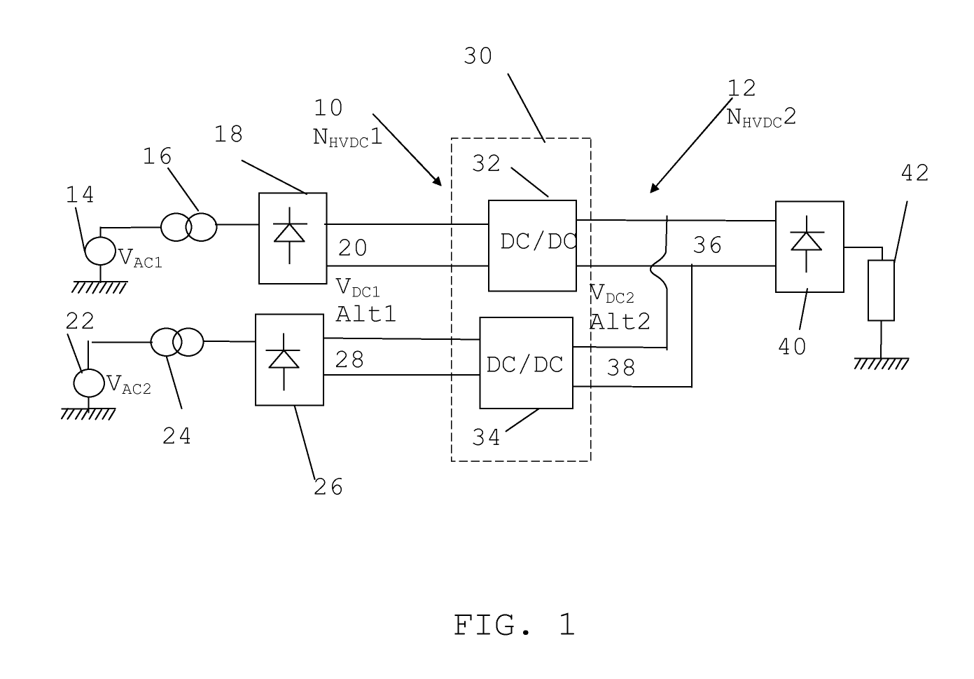

FIG. 1 shows a first embodiment of a power transmission system comprising a first direct current (DC) power transmission network N_{HVDC1} 10 and a second DC power transmission network N_{HVDC2} 12, where both networks are HVDC networks. The first DC power transmission network 10 comprises a group of rectifiers, which group here comprises a first rectifier 18 and a second rectifier 26. The first rectifier 18 is connected to a corresponding first alternating current (AC) voltage source 14 such as a generator. In this first embodiment the first rectifier 18 is connected to the first AC voltage source 14 via a first transformer 16. The second rectifier 26 is likewise connected to a corresponding AC source. In this first embodiment the corresponding source is a second AC source 22, which may also be a generator, and the second rectifier 26 is connected to this source via a second transformer 24.

The rectifiers are thus connected to different AC sources.

The group of rectifiers may be provided in a common converter station. All rectifiers in the group are furthermore connected to a DC/DC converter station 30 using a group of corresponding transmission lines, each connected between a corresponding rectifier and the DC/DC converter station. The first rectifier 18 is thus connected to the DC/DC converter station 30 via a first transmission line 20 and the second rectifier 26 is connected to the DC/DC converter station 30 via a second transmission line 28. In this embodiment the first DC power transmission network 10 is a bipole network. For this reason the first and second transmission lines 20 and 28 each has two poles. The first and second transmission lines 20 and 28 are furthermore connected in parallel to the DC/DC converter station 30. The group of rectifiers are thus connected in parallel to the converter station via corresponding transmission lines 20 and 28.

The first DC transmissions network 10 does therefore comprise the group of rectifiers comprising the first and second rectifiers 18 and 26, the corresponding first and second transmission lines 20 and 28 and the DC/DC converter station 30, which is also providing an interface between the two networks 10 and 12.

In this first embodiment the DC/DC converter station 30 comprises a group of converters, one for every rectifier in the group of rectifiers. Each rectifier is thus connected to a corresponding DC/DC converter. This means that in this example there is a first DC/DC converter 32 being connected to the first rectifier 18 via the first transmission line 20 and a second DC/DC converter 34 connected to the second rectifier via the second transmission line 28. A positive pole of the first rectifier 18 is thus connected to a positive pole of the first DC/DC converter 32 via a first conductor of the first power transmission line 20. A negative pole of the first rectifier 18 may also be connected to a negative pole of the first DC/DC converter 32, for instance via a second conductor of the first power transmission line 20. In a similar manner a positive pole of the second rectifier 26 is connected to a positive pole of the second DC/DC converter 34 via a first conductor of the second power transmission line 28. A negative pole of the second rectifier 26 may also be connected to a negative pole of the second DC/DC converter 34, for instance via a second conductor of the second power transmission line 28.

The two DC/DC converters 32 and 34 are in turn connected to the second DC network 12. In this first embodiment the DC/DC converters 32 and 34 are connected in parallel to the second DC network 12. Each DC/DC converter 32 and 34 has a first DC side providing an interface to the first DC network 19 and a second DC side interfacing the second DC network 12. For the DC/DC converters 32 and 34, the first sides are connected to different transmission lines in the first DC network 10. On the second DC sides the DC/DC converters 32 and 34 are connected to a common transmission line 36. All DC/DC converters are on the second side connected in parallel to the same transmission line 36 of the second DC network 12. This transmission line 36 is in turn connected to an inverter 40 for supply of power to a load 42 in an AC network. A positive pole of the second DC side of the first DC/DC converter 32 is thus connected to a positive pole of the inverter 40 via a first conductor of the transmission line 36, while a negative pole of the second DC side of the first DC/DC converter 32 may be connected to a negative pole of the inverter 40 via a second conductor of the transmission line 36. In a similar manner, a positive pole of the second DC side of the second DC/DC converter 34 is connected to the positive pole of the inverter 40 via the first conductor of the transmission line 36, while a negative pole of the second DC side of the second DC/DC converter 34 may be connected to the negative pole of the inverter 40 via the second conductor of the transmission line 36.

The two rectifiers 18 and 26 are thus each connected to an AC source 14 and 22 via a transformer 16 and 24. A part of the first DC network 10 may be provided on or placed at a high altitude Alt1, for instance the rectifiers 12 and 26 and parts of the transmission lines 20 and 28. The rectifiers 18 and 26 are here furthermore set to convert from AC to a first DC voltage V_{DC1}, which is the DC voltage level of the first DC network 10. The first DC power transmission network 10 thus operates at the first voltage level V_{DC1} for delivering power to the second DC power transmission network 12. The DC/DC converters 32 and 34 of the converter station 30 in the first DC network 10 are on the other hand provided on or placed at a second altitude Alt2 that is lower than the first altitude. The DC/DC converters 32 and 34 convert between the first DC voltage V_{DC1} and a second DC voltage V_{DC2}, which is the voltage level of the second DC network 12. The second DC power transmission network 12 thus operates at the second voltage level V_{DC2}. The DC/DC conversion is thus from the first DC voltage level V_{DC1} to the second DC voltage level V_{DC2}, which is higher than the first DC voltage V_{DC1}.

The first altitude Alt1 may be at least twice as high as the second altitude Alt2 and the second DC voltage V_{DC2} is with advantage at least two times higher than the first DC voltage V_{DC1} and in one case at least three times higher. The first altitude may as an example be in the range 4500-5300 m above sea level and the second altitude may be half of that or lower. The first voltage level V_{DC1} is in one example 400 kV and the second 800 kV or 1100 kV. The distance between the rectifiers and the DC/DC converter(s) may be in the range of 700-800 km.

The DC/DC converters are typically provided for long distance DC power transmission and are therefore connected to at the above-mentioned inverter 40 in order to supply the load 42 in the remote AC system(s) with power.

The use of lower first DC voltage V_{DC1} allows for a reduction of the insulation level at the first altitude Alt1 for a given power supply level, which is of importance since this insulation level is mostly dependent on the height above sea level. Decreased power transmission capacity due to the lowered voltage is mitigated through the use of more than one rectifier.

The use of parallel DC/DC converters according to the first variation has the advantage of reducing the transmission losses as well as providing a greater flexibility in the use of AC sources. The two parallel DC/DC converters do for instance allow one source to be a wind power source and the other a hydro power source.

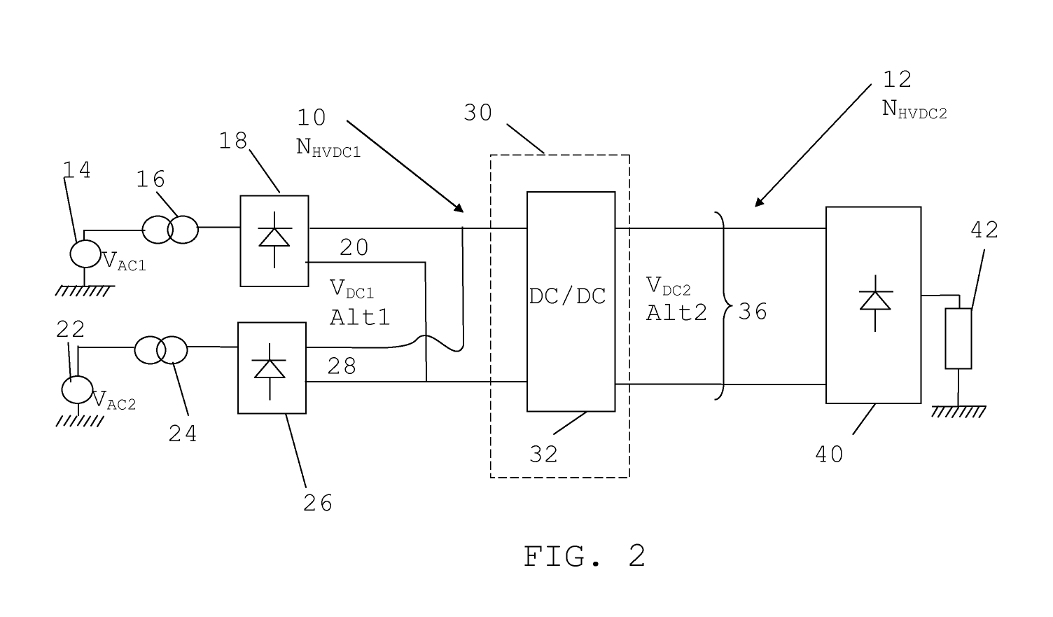

A second embodiment of a direct current power transmission system comprises the first DC power transmission network 10 connected to the second DC network 12 in the way shown in FIG. 2. The first network 10 comprises a group of rectifiers 18 and 28, each connected to an AC source 14, 22 via a transformer 16, 24 in the same way as in the first embodiment. The first DC network 10 is also in this case a bipole network. However in this embodiment of the invention the DC/DC converter station 30 only comprises one DC/DC converter 32. The rectifiers 18 and 26 are each provided with an AC side and a DC side, where the AC side is connected to a corresponding source via a transformer in the same way as in the first embodiment. However, in this second embodiment the DC sides of the rectifiers 18 and 26 in the group are connected in parallel to the single DC/DC converter 32. The DC side of the first rectifier 18 is thus connected to the first transmission line 20 and the DC side of the second rectifier 26 is connected to the second transmission line 28. The first and second transmission lines are then connected in parallel to the first DC side of the DC/DC converter 32, which may be connected, on the second DC side, to a single transmission line 36 leading to inverter 40 and load 42. The positive pole of the first rectifier 18 is thus connected to a positive pole of the first side of the DC/DC converter 32 via the first conductor of the first power transmission line 20. The negative pole of the first rectifier 18 may also be connected to the negative pole of the first side of the DC/DC converter 32, for instance via the second conductor of the first power transmission line 20. The positive pole of the second rectifier 26 is also connected to the positive pole of the first side of the DC/DC converter 32 via a first conductor of the second power transmission line 28. The negative pole of the second rectifier 26 may also be connected to the negative pole of the first side of the DC/DC converter 32, for instance via the second conductor of the second power transmission line 28.

Above were described two embodiments of the invention. There are further variations that are possible. It is possible that the sources are in fact the same source. The rectifiers may thus be connected to the same AC source. This means that the group of rectifiers may each supply power from the source to the DC/DC converter station. In some cases it is possible to remove the transformers. In other cases it is possible that reactive energy compensation equipment, such as static VAR compensators are provided between source and rectifier. It should also be realized that the use of bipole systems is a mere example. The invention can just as well employ for instance a monopole system.

In the above described embodiments the system of the invention comprises both the first and second DC network. In some variations of the invention the system only comprises the first network.

From the foregoing discussion it is evident that the present invention can be varied in a multitude of ways. It shall consequently be realized that the present invention is only to be limited by the following claims.

1-7. (canceled)

8. A direct current power transmission system comprising a first direct current power transmission network operating at a first voltage level for delivering power to a second direct current power transmission network operating at a second voltage level, said first direct current power transmission network comprising:
a DC/DC converter station comprising at least one DC/DC converter providing an interface between the first and second direct current power transmission networks;
a group of rectifiers, each connected to the same alternating current source, where the rectifiers each supply power from the source to the DC/DC converter station, and the distance between the rectifiers and the DC/DC converter station is in the range 700-800 km; and
a group of transmission lines, each connected between a corresponding rectifier and the DC/DC converter station so that the rectifiers are connected to the DC/DC converter station using the group of transmission lines,
wherein the first voltage level is 400 kV and the second voltage level is 800 or 1100 kV and the rectifiers are placed at a first altitude and the DC/DC converter station is placed at a second altitude, where the first altitude is in the range 4500-5300 m, is higher than the second altitude and at least twice as high as the second altitude.

9. The direct current power transmission system according to claim 8, wherein the second voltage level is at least two times higher than the first voltage level.

10. The direct current power transmission system according to claim 8, wherein the second voltage level is at least three times higher than the first voltage level.

11. The direct current power transmission system according to claim 8, further comprising the second direct current power transmission network.

12. The direct current power transmission system according to claim 11, wherein the second direct current power transmission network comprises an inverter for delivering power to an AC network.

13. The direct current power transmission system according to claim 8, wherein the DC/DC converter station comprises a single DC/DC converter and all rectifiers are connected to the single DC/DC converter in parallel.

14. The direct current power transmission system according to 8, wherein the DC/DC converter station comprises a group of DC/DC converters, one for every rectifier and connected in parallel to the second direct current power transmission network, where each rectifier is connected to a corresponding DC/DC converter.

15. The direct current power transmission system according to claim 9, further comprising the second direct current power transmission network.

16. The direct current power transmission system according to claim 10, further comprising the second direct current power transmission network.

17. The direct current power transmission system according to claim 9, wherein the DC/DC converter station comprises a single DC/DC converter and all rectifiers are connected to the single DC/DC converter in parallel.

18. The direct current power transmission system according to claim 10, wherein the DC/DC converter station comprises a single DC/DC converter and all rectifiers are connected to the single DC/DC converter in parallel.

19. The direct current power transmission system according to claim 11, wherein the DC/DC converter station comprises a single DC/DC converter and all rectifiers are connected to the single DC/DC converter in parallel.

20. The direct current power transmission system according to claim 12, wherein the DC/DC converter station comprises a single DC/DC converter and all rectifiers are connected to the single DC/DC converter in parallel.

21. The direct current power transmission system according to 9, wherein the DC/DC converter station comprises a group of DC/DC converters, one for every rectifier and connected in parallel to the second direct current power transmission network, where each rectifier is connected to a corresponding DC/DC converter.

22. The direct current power transmission system according to 10, wherein the DC/DC converter station comprises a group of DC/DC converters, one for every rectifier and connected in parallel to the second direct current power transmission network, where each rectifier is connected to a corresponding DC/DC converter.

23. The direct current power transmission system according to 11, wherein the DC/DC converter station comprises a group of DC/DC converters, one for every rectifier and connected in parallel to the second direct current power transmission network, where each rectifier is connected to a corresponding DC/DC converter.

24. The direct current power transmission system according to 12, wherein the DC/DC converter station comprises a group of DC/DC converters, one for every rectifier and connected in parallel to the second direct current power transmission network, where each rectifier is connected to a corresponding DC/DC converter.
